(19) United States
(12) Patent Application Publication
(10) Pub. No.: US 2009/0170659 A1
(43) Pub. Date: Jul. 2, 2009

(54) METHOD FOR OPERATING AN AUTOMATIC FRICTION CLUTCH

(75) Inventors: Rainer Petzold, Friedrichshafen (DE); Peter Herter, Friedrichshafen (DE); Franz Bitzer, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, FRIEDRICHSHAFEN (DE)

(21) Appl. No.: 12/302,096

(22) PCT Filed: Apr. 25, 2007
(86) PCT No.: PCT/EP07/54025

§ 371 Date: Nov. 24, 2008

(30) Foreign Application Priority Data
May 24, 2006 (DE) 10 2006 024290.4

(51) Int. Cl. B60W 10/02

(52) U.S. Cl. 477/174

(57) ABSTRACT

A method for operating an automated friction clutch in which a clutch load, corresponding to an energy input, is determined and the operation of the clutch is controlled as a function of the clutch load determined. Glazing of the clutch lining that results from too low an energy input, in relation to the slipping operation time of the clutch, is compensated by a specific increase of the clutch load, while premature wear is prevented by a specific reduction of the clutch load.

This application is a national stage completion of PCT/EP2007/054025 filed Apr. 25, 2007, which claims priority from German Application Serial No. 10 2006 024290.4 filed May 24, 2006.

### FIELD OF THE INVENTION

The invention concerns a method for operating an automated friction clutch.

### BACKGROUND OF THE INVENTION

Automated friction clutches, i.e., friction-based clutches not actuated directly by a user, have been used for a long time especially in motor vehicles. For that reason the present invention will be described below considering the example of a motor vehicle clutch, although it is not limited to motor vehicle clutches, but can basically be used with all clutches that can be subjected to different clutch loads during various clutch processes.

Particularly in motor vehicles with automated transmissions, automated friction clutches are routinely activated during gear changes and starting processes. Besides this, however, they are also increasingly used in vehicles with manual-shift transmissions. In these, the desired gear is indicated directly by the driver, usually in the form of an electric or electronic signal, which is processed as necessary by a control device and finally brings about the activation of actuators which control the actual clutch and shift process.

Even in cases when a clutch pedal to be actuated by the driver is provided, control of the clutch position by actuators offers various advantages in relation to the forces to be applied by the driver, the pedal paths and the adjustment accuracy of the clutch and, especially in particular conditions of the vehicle, of the transmission or clutch itself. The controls of automated friction clutches are usually designed to produce the most advantageous possible driving properties of the vehicles. These include that, during starting processes, a relatively extensive slipping range of the friction clutch is provided, which enables the driver to gauge the speed increase of the vehicle accurately and to maneuver comfortably, and makes it possible for him, even on relatively steep inclines, to hold the vehicle stationary for a short time by actuating the accelerator pedal, but without actuating a brake.

In such a case, the control system for the automated clutch is generally designed such that it is optimized for starting situations or clutch processes, which are commonly expected.

Particularly with medium-sized and heavy commercial vehicles, however, the starting situations can vary over a wide range, depending upon the loading and the road inclination at the time, so the clutch is often operated below or above its design range and thus also below or above the clutch loading envisaged.

When a clutch is operated over a longer period below the clutch load envisaged, this leads to “glazing” of the clutch lining. In turn, glazing results in a negative friction coefficient variation, i.e., the friction coefficient of the clutch decreases as the sliding speed increases. Negative friction coefficient variations are a cause of jerkiness of the clutch, which is perceived as drive train oscillations. Particularly for driving comfort reasons, clutch jerkiness should be avoided.

On the other hand, when a clutch is operated over a longer period above its design range or clutch load envisaged, this leads to premature clutch wear which, understandably, should also be avoided.

As is known, the clutch load is a function of the energy input into the clutch during the slipping phase of a clutch process. This energy can be determined as the product of the drive torque, the slipping rotation speed and the slipping operation time. The slipping rotation speed corresponds to the difference between the clutch input speed and the clutch output speed. Thus, the energy input can be calculated from the equation:

E=M*(nᵢₙ−nₒᵤₜ)*t

In the above equation:

E is the energy taken up by the clutch as friction work

M is the input torque

nᵢₙ is the input rotation speed

nₒᵤₜ is the output rotation speed of the clutch, and

t is the slipping operation time.

Therefore, it is clear that the energy input into the clutch can be influenced by the input torque, the difference between the input and output speeds and the slipping operation time. Against that background it is basically already known to monitor the clutch load or energy input into a clutch and to control the operation of the clutch as a function of the clutch load determined.

For example, DE 33 34 725 A1 shows a device for protecting a clutch against over-heating in which a drive torque transmitted by the clutch or applied by a drive engine to a clutch and the difference between a clutch input speed and a clutch output speed are determined. Their product is calculated and this product is associated with a precautionary rest time with the help of a table. The actual slipping operation time, in each case, is compared with the said precautionary rest time and, if the latter is exceeded, a warning signal is produced. This is intended to avoid overheating of the clutch.

From DE 103 12 088 A1, a method for operating a drivetrain of a motor vehicle is known, in which the energy input or the temperature of a clutch is monitored and, if limit values are exceeded, the input torque to the clutch is reduced. The purpose of this method too is to avoid damage and overheating of the friction clutch.

In both of the documents, in each case a current clutch process is monitored in order to avoid damaging the clutch during the clutch process in progress. No provision is made, nor indeed is it possible with the devices and methods described in these documents, to determine an average clutch load occurring over a longer operating time as a measure for glazing that results from this or for excessive wear of the clutch.

Against this background, the purpose of the present invention is to propose a method for operating an automated friction clutch, by way of which glazing of the clutch lining that occurs over a longer operating period or its excessive wear can be avoided.

In this context, the term “average clutch load” is understood to mean that during one or more consecutive clutch processes or, if necessary, all the clutch processes since the clutch was brought into service, the total clutch load corresponding to the energy input is determined in relation to the total slippage operation time. This clutch load is then compared with a predetermined or specified average clutch load and, if the determined clutch load differs from the specified clutch load the system reacts accordingly in the manner indicated by the invention during the subsequent clutch processes.

### DETAILED DESCRIPTION OF THE INVENTION

The invention is based on the recognition that possible clutch damage caused by below-average or above-average energy input can be reduced or avoided, respectively, by a specific increase or reduction of the energy input to the clutch.

Accordingly, the invention begins from a method for operating an automated friction clutch, in which a clutch load corresponding to an energy input is determined and the operation of the clutch is controlled as a function of the clutch load determined.

To achieve the stated objective, it is, therefore, provided that an average clutch load is determined in relation to a slippage operation time and that, if the clutch load is below a specified limit value range, the clutch is operated at an increased load while, if the clutch load is above the limit value range it is operated at a reduced load, in each case until the limit value range has been reached again.

Thus, according to the invention, falling below or exceeding the average clutch load is compensated by a specific energy input adjustment so as to keep the clutch load within a specified range of limit values.

According to a preferred embodiment of the invention, the average clutch load is determined from the average energy input. For this purpose, at each clutch process the energy inputs are calculated or measured in the manner outlined earlier, and the energy inputs occurring over a longer operating time and determined in relation to the associated slipping operation time. The values obtained are a measure of the average clutch load. If this deviates downward or upward from a specified limit value range, then the energy input is respectively increased or reduced by suitably influencing the energy input determining parameters until the limit value range is reached again.

Another way to determine the clutch load is to observe the operating behavior of the clutch and to infer the condition of the clutch from this operating behavior. In particular, an average clutch load below the limit value range can be inferred from jerky clutch behavior. As already explained earlier, an energy input below average over a long operating period leads to “glazing” of the clutch lining that results in a negative friction coefficient variation which, in turn, is a cause of clutch jerkiness. Jerky clutch behavior can be inferred by measuring drive train oscillations.

According to another feature of the invention, an average clutch load above the limit value range is determined from the clutch wear, which can be determined from the end position of the fully engaged clutch.

As already explained earlier, the energy input can basically be influenced by the energy input determining parameters, namely the input torque, the difference between the input speed and the output speed of the clutch and the slipping operation time.

In addition, it has already been mentioned that automated friction clutches are often used in combination with our automated or automatic transmission. The clutch and the transmission are controlled by an overall control system. Particularly in heavy commercial vehicles with up to 12 or 18 gears, in general several gears can be used as starting gears. The specific starting gear is chosen as a function of the current driving situation, the load condition of the vehicle, the inclination of its parking position, etc. An overall control system determines the conditions that characterize the driving situation and selects a starting gear that is optimum for those conditions in normal operation.

With a vehicle of this type, according to a preferred version of the invention, operation with an increased clutch load is carried out by selecting starting gears that are higher than the starting gear which is optimum for the driving situation at the time, and operation with a reduced clutch load is correspondingly carried out by selecting starting gears lower than the optimum starting gear for the driving situation at the time. Accordingly, if the clutch linings are glazed because of below-average clutch loading, the energy input to the clutch can be increased deliberately by the selection of starting gears higher than, i.e., above the optimum starting gear, the result of which is that the glazed layer is abraded away and the glazed condition is therefore eliminated.

On the other hand, if above-average clutch loading is determined, then in a corresponding manner the energy input into the clutch is reduced by selecting starting gears lower than the optimum starting gear, until the specified limit value range has been reached again.

It has been shown that, in general, increasing or reducing the energy input for a relatively short time (a few starting processes) is sufficient to return to the specified limit value range.

1-6. (canceled)

7. A method of operating an automated friction clutch in which a clutch load, corresponding to an energy input, is determined and operation of the clutch is controlled as a function of the determined clutch load, the method comprising the steps of:
determining an average clutch load in relation to a slipping operation time of the clutch,
if a clutch load lower than the specified limit value range is detected, operating the clutch at an increased clutch load until a specified limit value range is reached, and
while, if a clutch load higher than the specified limit value range is detected, operating the clutch at a reduced clutch load until the specified limit value range is reached.

8. The method according to claim 7, further comprising the step of determining the average clutch load by an average energy input to the clutch.

9. The method according to claim 7, further comprising the step of determining the average clutch load from an operating behavior of the clutch.

10. The method according to claim 9, further comprising the step of determining an average clutch load below the specified limit value range from a jerkiness behavior of the clutch.

11. The method according to claim 7, further comprising the step of determining a clutch load above the limit value range from clutch wear.

12. The method according to claim 7, further comprising the steps of operating the clutch at an increased clutch load by selecting starting gears higher than an optimum starting gear for a driving situation at the time, and operating the clutch at a reduced clutch load by selecting starting gears lower than the optimum starting gear for the driving situation at the time when the friction clutch cooperates with one of an automatic or automated transmission having several starting gears that are selected automatically as a function of the driving situation at the time.

13. A method for operating an automated friction clutch which cooperates with one of an automatic or automated transmission that has several starting gears that are selected automatically depending on a current driving situation, the method comprising the steps of:
determining an average clutch load from one of an operating behavior of the clutch or an average energy, which is input to the clutch during a time of clutch slipping operation time;
if the determined average clutch load is lower than the specified limit value range, operating the clutch at an increased clutch load by selecting a starting gear higher than an optimum starting gear for the current driving situation until a specified limit value range is reached; and
if the determined average clutch load is higher than a specified limit value range, operating the clutch at a reduced clutch load by selecting a starting gear lower than the optimum starting gear for the current driving situation until a specified limit value range is reached.
